(19) United States
(12) Patent Application Publication
(10) Pub. No.: US 2017/0232688 A1
(43) Pub. Date: Aug. 17, 2017

(54) Incorporation Of Jamming Technologies In Tooling For Composites Processing

(71) Applicant: General Electric Company, Schenectady, NY (US)

(72) Inventor: Aaron Todd Sellinger, Cincinnati, OH (US)

(21) Appl. No.: 15/043,649

(22) Filed: Feb. 15, 2016

(51) Int. Cl. B29C 70/34

(52) U.S. Cl. CPC B29C 70/342; B29C 70/345; B29K 2105/0872

(57) ABSTRACT

The disclosure is directed to a method of manufacturing a layered component. The method includes changing a working pressure in a bladder having a shape and containing a fluid and a plurality of jamming media to convert the bladder into a rigid state. The working pressure is different than an ambient pressure. One or more layers of precursor material are laid on the bladder while the bladder is in the rigid state. The one or more layers of precursor material are processed to form the layered component. The working pressure in the bladder is returned to the ambient pressure to return the bladder to a flaccid state. The bladder, while in the flaccid state, is removed from the layered component.

### FIELD OF THE INVENTION

The present disclosure generally relates to a method of forming a composite component or other layered component and, more particularly, a method of forming a composite or layered component using a bladder.

### BACKGROUND OF THE INVENTION

Many aircraft components (e.g., airfoils, ducts, panels, etc.) are typically constructed from layered materials such as polymeric matrix composites and ceramic matrix composites. Generally, such composite components are formed by placing uncured composite material into a mold or onto a mandrel having the desired shape of the finished composite component. The mold or mandrel and the uncured composite material are then placed into an oven or an autoclave, which heats the uncured composite material to a temperature sufficient for curing thereof.

Nevertheless, a different mold or mandrel is required for each different type of composite component. For example, one mold or mandrel is required to make an L-shaped tube, while a second, different mold or mandrel is required to make an S-shaped tube. The use of a different mold or mandrel for each different composite component type is expensive. Specifically, material and fabrication (e.g., machining) costs for each mold and mandrel are significant. Switching between different molds and/or mandrels to produce different composite component types can be time-consuming and may result in expensive machine down time. Furthermore, each mold must be stored and maintained when not in use, thereby resulting in further expense. Accordingly, a method of forming composite components that does not require the use a different mold or mandrel to form each different composite component type would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the disclosure is directed to a method of manufacturing a layered component. The method includes changing a working pressure in a bladder having a shape and containing a fluid and a plurality of jamming media to convert the bladder into a rigid state. The working pressure is different than an ambient pressure. One or more layers of precursor material are laid on the bladder while the bladder is in the rigid state. The one or more layers of precursor material are processed to form the layered component. The working pressure in the bladder is returned to the ambient pressure to return the bladder to a flaccid state. The bladder, while in the flaccid state, is removed from the layered component.

In another aspect, the present disclosure is directed to a method of forming a cured composite component. The method includes positioning a bladder in a first position in a mold. A first working pressure is created in the bladder containing a fluid and a plurality of jamming media to convert the bladder into a rigid state. The first working pressure is different than an ambient pressure. A first set of one or more layers of uncured composite material is laid on the bladder while the bladder is in the rigid state. The first set of one or more layers of uncured composite material is cured to form a first cured composite component. The first working pressure in the bladder is released to return the bladder to a flaccid state. The bladder, while in the flaccid state, is removed from the first cured composite component. The bladder is positioned in a second position in the mold. A second working pressure is created in a bladder to convert the bladder into the rigid state. The second working pressure is different than the ambient pressure. A second set of one or more layers of uncured composite material is laid on the bladder while the bladder is in the rigid state. The second set of one or more layers of uncured composite material is cured to form a second cured composite component. The second working pressure in the bladder is released to return the bladder to the flaccid state. The bladder is removed while in the flaccid state from the second cured composite component.

In a further aspect, the present disclosure is directed to a mold assembly for forming a composite component. The mold assembly includes a permanently rigid mold and a bladder having an internal chamber containing a fluid and a plurality of jamming media. The bladder is in a rigid state when a working pressure different than an ambient pressure is applied to the internal chamber, and the bladder is in a flaccid state when the internal chamber is the same as the ambient pressure. One or more layers of uncured composite material are laid on the permanently rigid mold and the bladder when in the rigid state form a composite component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended FIGS., in which:

FIG. 1 is a perspective view of a bladder for use in forming a layered component in accordance with the embodiments disclosed herein;

FIG. 2 is a cross-sectional perspective view of the bladder taken generally about Line 2-2 in FIG. 1, illustrating the internal features thereof when in a flaccid state;

FIG. 3 is a schematic view of a mold incorporating the bladder of FIGS. 1 and 2, illustrating the bladder in a rigid state;

FIG. 4 is a flow chart illustrating a method for manufacturing a composite component in accordance with the embodiments disclosed herein;

FIG. 5 is a cross-sectional perspective view of the bladder taken generally about Line 2-2 in FIG. 1, illustrating the internal features thereof when in the rigid state;

FIG. 6 is a cross-sectional view of the bladder taken generally about Line 2-2 in FIG. 1, illustrating one or more layers precursor material laid thereon;

FIG. 7 is a schematic view of an autoclave, illustrating the bladder and the one or more layers of precursor material positioned therein for curing;

FIG. 8 is a schematic view of a curing press, illustrating the bladder and the one or more layers of precursor material positioned thereon for curing;

FIG. 9 is a cross-sectional view of the bladder and the layered component taken generally about Line 2-2 in FIG. 1, illustrating the relative positioning of the bladder and the layered component after the bladder returns to the flaccid state;

FIG. 10A is a perspective view of a tube formed in accordance with the embodiments disclosed herein;

FIG. 10B is a perspective view of a duct having a rectangular cross-section formed in accordance with the embodiments disclosed herein;

FIG. 10C is a perspective view of an airfoil formed in accordance with the embodiments disclosed herein;

FIG. 10D is a perspective view of a curved panel produced in accordance with the embodiments disclosed herein; and

FIG. 11 is a flow chart illustrating an alternate method for manufacturing a composite component.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

The term “thermoplastic” is used herein to mean any material formed from a polymer which softens and flows when heated; such a polymer may be heated and softened a number of times without suffering any basic alteration in characteristics, provided heating is below the decomposition temperature of the polymer. Examples of thermoplastic polymers include, by way of illustration only, polyolefins, polyesters, polyamides, polyurethanes, acrylic ester polymers and copolymers, polyvinyl chloride, polyvinyl acetate, etc. and copolymers thereof.

As used herein, “glass transition temperature” refers to the temperature at which an amorphous polymer or an amorphous portion of a crystalline polymer transitions from a hard and brittle glassy state to a rubbery state. For example, the glass transition temperature (T_{g}) may be determined by dynamic mechanical analysis (DMA) in accordance with ASTM E1640-09. A Q800 instrument from TA Instruments may be used. The experimental runs may be executed in tension/tension geometry, in a temperature sweep mode in the range from −120° C. to 150° C. with a heating rate of 3° C./min. The strain amplitude frequency may be kept constant (2 Hz) during the test. Three (3) independent samples may be tested to get an average glass transition temperature, which is defined by the peak value of the tan δ curve, wherein tan δ is defined as the ratio of the loss modulus to the storage modulus (tan δ=E″/E′).

As used herein, the prefix “nano” refers to the nanometer scale (e.g., from about 1 nm to about 999 nm). For example, particles having an average diameter on the nanometer scale (e.g., from about 1 nm to about 999 nm) are referred to as “nanoparticles”.

In the present disclosure, when a layer is being described as “on” or “over” another layer or a mandrel, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

The methods of manufacturing a layered component (e.g., a composite component) disclosed herein include changing a working pressure in a bladder having a first shape and/or orientation for forming a first layered component to convert the bladder into a rigid state. One or more layers of precursor material are laid on the bladder while the bladder is in the rigid state and then processed to form the first layered component. The working pressure in the bladder is returned to the ambient pressure to place the bladder into a flaccid state, and the bladder then is removed from the first layered component. The bladder can then be manipulated into a second shape and/or orientation to form a second layered component. In this respect, the bladder may be incorporated in a mold or mandrel for use in producing multiple different types of layered components. As such, the methods disclosed herein reduce the cost associated with producing composite and other layered components.

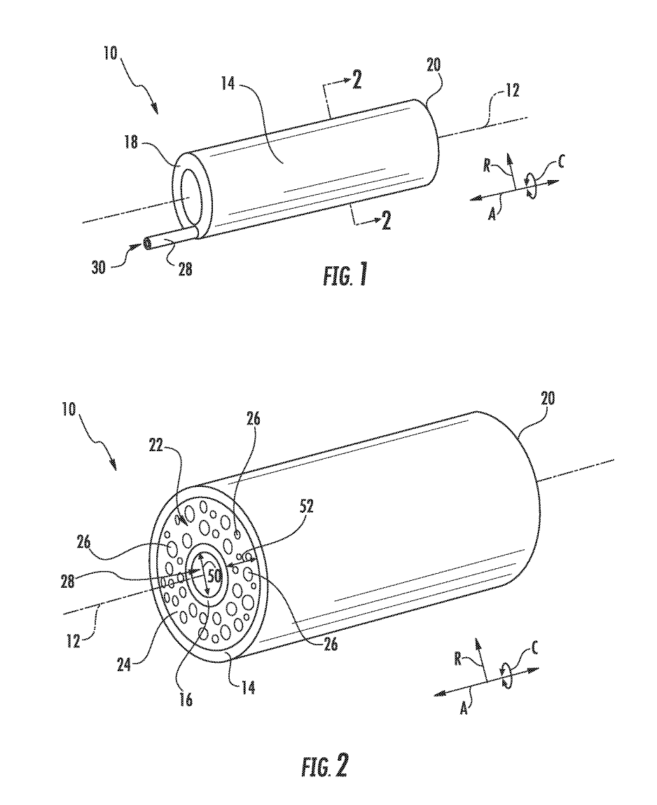

FIGS. 1 and 2 illustrate one embodiment of a bladder 10 having a longitudinal centerline 12 for use in forming a composite component. As shown therein, the bladder 10 defines an axial direction A, a radial direction R, and a circumferential direction C. In general, the axial direction A extends parallel to the longitudinal centerline 12, the radial direction R extends orthogonally outwardly from the longitudinal centerline 12, and the circumferential direction C extends concentrically around the longitudinal centerline 12.

As illustrated in FIGS. 1 and 2, the bladder 10 includes an outer longitudinal wall 14 and an inner longitudinal wall 16, both of which extend axially between a first end wall 18 and a second end wall 20. The inner longitudinal wall 16 is positioned radially inwardly from and is circumferentially enclosed by the outer longitudinal wall 14. The walls 14, 16, 18, 20 are formed from silicone or another suitable elastomer.

As best illustrated in FIG. 2, the outer and inner longitudinal walls 14, 16 and the first and the second end walls 18, 20 collectively define a chamber 22 therebetween. The chamber 22 contains a fluid 24 and a plurality of jamming media 26. The fluid 24 is preferably air or oil, but may be any suitable fluid as well. The plurality of jamming media 26 may be coarse grains or beads, plates, and/or laminate structures. Although, the plurality of jamming media 26 may be any suitable material having any suitable shape (e.g., spherical, cube-like, etc.) or combination thereof. The plurality of jamming media 26 may be the same size or different sizes. In the embodiment shown in FIGS. 1 and 2, the inner longitudinal wall 16 also defines and circumferentially encloses a space 28 through which the longitudinal centerline 12 extends. In the embodiments that lack the inner longitudinal wall 16, the chamber 22 occupies all space radially inward of the outer wall 14. In these embodiments, the longitudinal centerline 12 extends through the chamber 22.

The shape of the bladder 10 may be changed by shifting the position of at least some of the plurality of jamming media 26 in the chamber 22. Specifically, the weight of the plurality of jamming media 26 retains the shape of the walls 14, 16, 18, 20, which may be deformed due to the elastomeric nature thereof. For example, the plurality of jamming media 26 may be shifted within the chamber 22 so that the bladder 10 forms an L-shape. In this respect, the weight of the plurality of jamming media 26 retains the bladder 10 in the L-shape until the position of at least some of the plurality of jamming media 26 is shifted into a different shape.

In the embodiment shown in FIG. 1, a stem 30 defining an inlet port 32 extends outwardly from the first end wall 18. A pump (not shown) may couple to the stem 30 to increase or decrease the amount of the fluid 24 in the chamber 22. This, in turn, changes a working pressure in the chamber 22 that is above or below the ambient pressure. The working pressure in the chamber 22 above or below the ambient pressure converts the bladder 10 into a rigid state, where the shape thereof cannot be changed. Releasing the working pressure and returning the chamber 22 to the ambient pressure places the bladder 10 in a flaccid state, which permits modification of the shape the bladder 10. The inlet port 18 may include a Schrader valve (not shown) or other suitable valve that permits selective retention or release of the working pressure in the chamber 22. In other embodiments, the stem 30 may extend outwardly from the second end wall 20 or the outer longitudinal wall 14.

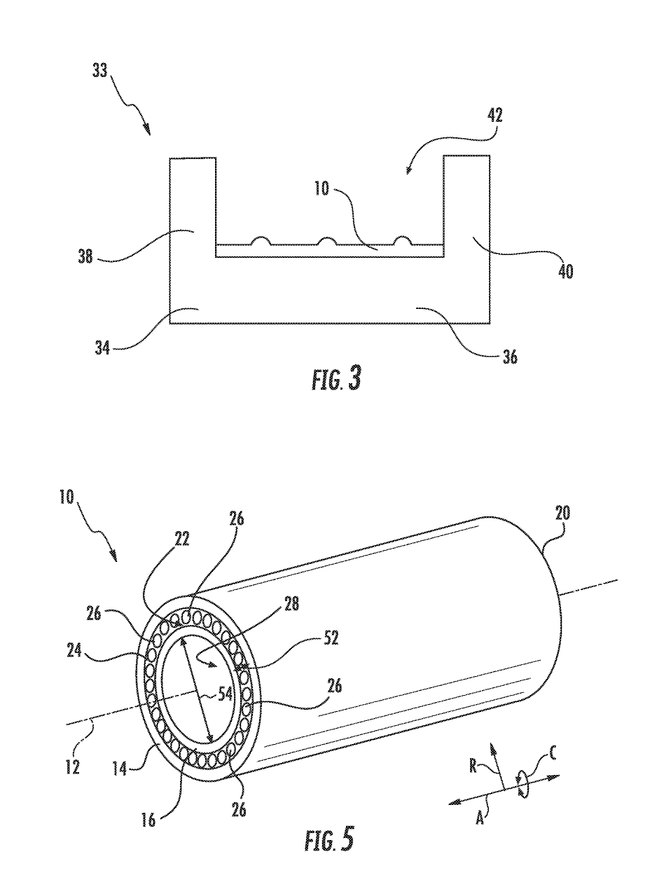

In some embodiments, the bladder 10 may be incorporated into a mold assembly 33 for forming layered components as shown in FIG. 3. More specifically, the embodiment of the mold assembly 33 shown in FIG. 3 includes mold 34 having a bottom wall 36, a first side wall 38, and an opposing second side wall 40. The walls 36, 38, 40 collectively define a mold cavity 42 into which precursor material (e.g., uncured composite material) is placed. In alternate embodiments, the mold 34 may have any suitable combination of walls, cavities, cores, or other features. The bladder 10 extends from the bottom wall 36 into the mold cavity 42 in the embodiment shown in FIG. 3. Nevertheless, the bladder 10 may be used to produce any feature. Furthermore, the bladder 10 may extend outwardly into the mold cavity 42 from any location on any walls 36, 38, 40 of the mold 34. In some embodiments, the mold 34 may include more than one bladder 10. In alternate embodiments, the bladder 10 may be incorporated into a mandrel (not shown) or other permanently rigid tooling used in forming composite components. The bladder 10 shown in FIG. 3 is in the rigid state.

As mentioned above, the shape of the bladder 10 may be modified by shifting the position of at least some of the plurality of jamming media 26 within the chamber 22. In this respect, layered components having various different features may be produced in the mold 34 by changing the shape and/or orientation of the bladder 10 in the mold cavity 42. For example, the mold 34 may produce layered components having an S-shaped passage (not shown) if the bladder 10 is oriented in an S-shape and layered components having an L-shaped passage (not shown) if the bladder 10 is oriented in an L-shape. Moreover, these different features may be produced without the need for different molds or mold pieces (e.g., cores). Furthermore, no permanent changes (e.g., via machining) need be made to the mold 34 or any pieces thereof to produce the different features.

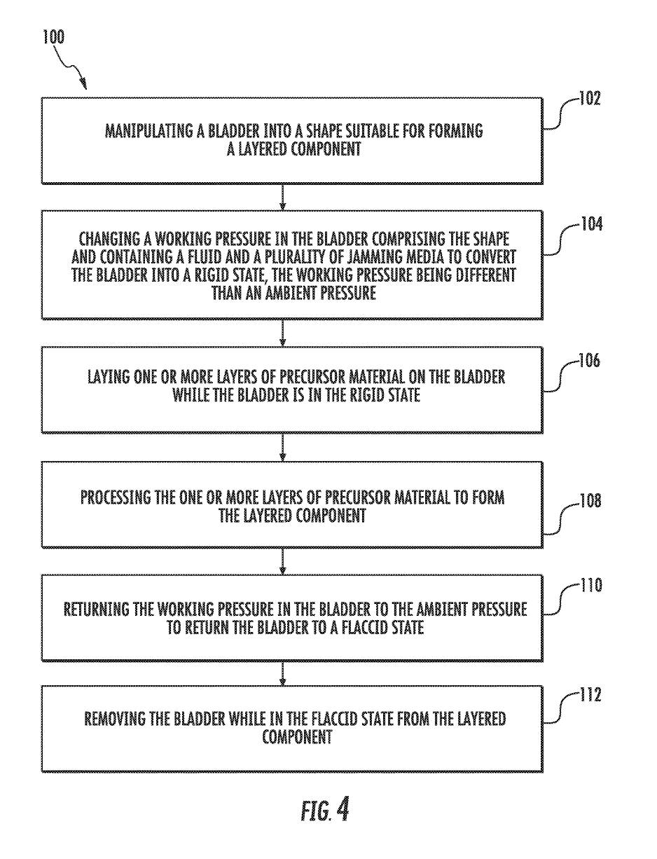

FIG. 4 is a flow chart illustrating an exemplary method (100) of manufacturing a layered component (e.g., a composite component or a thermoplastic component) in accordance with the embodiments disclosed herein. FIGS. 5-10 illustrate various aspects of the method (100).

Referring to FIG. 4, the bladder 10 is manipulated into a shape suitable for forming a layered component 46 (e.g., a cured composite component or a thermoplastic component) in (102). As discussed in greater detail above, the position of at least some of the plurality of jamming media 26 is shifted within the chamber 22 until the desired shape of the bladder 10 is achieved. The bladder 10 may be manipulated into a shape suitable for forming the entire layered component 46 (e.g., a tube) or only a portion thereof (e.g., an internal passage of a larger component).

In (104), a working pressure is changed in the chamber 22 of the bladder 10 so that the working pressure is different than the ambient pressure. In some embodiments, the pump decreases the amount of the fluid 24 in the chamber 22 (i.e., pumps out some of the fluid 24 from the chamber 22) to change the working pressure to be less than the ambient pressure (i.e., a vacuum). In other embodiments, the pump increases the amount of the fluid 24 in the chamber 22 (i.e., pumps additional fluid 24 into the chamber 22) to change the working pressure to be greater than the ambient pressure. Increasing the working pressure in the chamber 22 above the ambient pressure or decreasing the working pressure in the chamber 22 below the ambient pressure converts the bladder 10 from the flaccid state to the rigid state. Once in the rigid state, the position of the plurality of jamming media 26 in the chamber 22 cannot be changed. In this respect, changing the working pressure to be above or below the ambient pressure in the chamber 22 in accordance with (104) temporarily fixes the shape (e.g., the shape created in (102)) and orientation of the bladder 10. As illustrated in FIG. 5, a width 52 of the chamber 22 decreases and a diameter 54 of the space 28 increases when converting from the flaccid state (FIG. 2) to the rigid state (FIG. 5). Furthermore, the plurality of jamming media 26 becomes more tightly packed in the chamber 22 when the bladder 10 is in the rigid state.

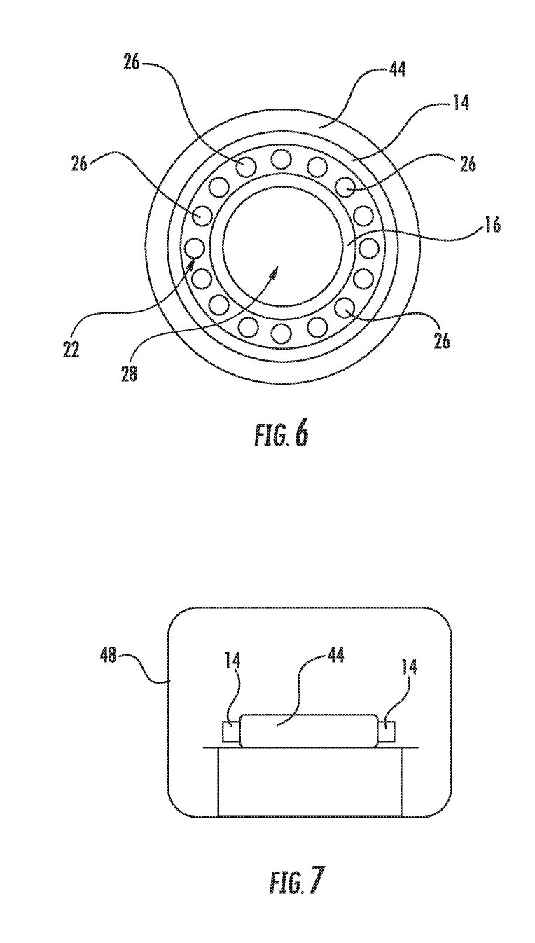

Referring to FIGS. 4 and 6, one or more layers of precursor material 44 are laid on the bladder 10 while the bladder 10 is in the rigid state in (106). The one or more layers of precursor material 44 may be one or more layers of uncured composite material or one or more layers thermoplastic material. In the embodiment shown in FIG. 6, for example, the one or more layers of precursor material 44 are wrapped around the bladder 10 to form a tube-like shape. In other embodiments, however, the one or more layers of precursor material 44 may be placed on the bladder 10 to form other shapes as well based on the particular shape and orientation of the bladder 10.

For example, the uncured composite material may be selected from the group consisting of, but not limited to, a ceramic matrix composite (“CMC”), a polymer matrix composite (“PMC”), a metal matrix composite (“MMC”), or a combination thereof. Suitable examples of matrix material for a CMC matrix is ceramic powder, including but not limited to, silicon carbide, aluminum-oxide, silicon oxide, and combinations thereof. Suitable examples of matrix material for a PMC include, but are not limited to, epoxy based matrices, polyester based matrices, and combinations thereof. Suitable examples of a MMC matrix material include, but are not limited to powder metals such as, but not limited to, aluminum or titanium that are capable of being melted into a continuous molten liquid metal which can encapsulate fibers present in the assembly, before being cooled into a solid ingot with incased fibers. The resulting MMC is a metal article with increased stiffness, and the metal portion (matrix) is the primary load caring element.

Referring again to FIG. 4, the one or more layers of precursor material 44 are processed in (108) to form a layered component 46. As mentioned above the one or more layers of the precursor material 44 may be one or more layers of uncured composite material. In this embodiment, the one or more layers of uncured composite material are heated to a temperature sufficient to cure the one or more layers of uncured composite material, thereby forming the composite component. Curing may be accomplished by any suitable method. For PMCs, curing activates or consolidates the matrix material of the whole assembled ply stack. Curing is accomplished by thermal activation of matrix media, usually, resins or polymers used to coat the fibers forming a thermoplastic with fiber encapsulation also known as thermosetting. For MMCs, curing is accomplished through melting of the matrix media, usually, powder metal used to coat the fibers into metallic slurry with fibers present, and then cooled to a continuous metallic with encapsulated fibers when cooled. The metal matrix media includes, but is not limited to, lighter metals such as aluminum, magnesium, or titanium. For CMCs, curing is accomplished by thermal activation of the binder followed by pyrolyzing the binder to form carbon deposits, to encapsulate or bond together the fibers. The encapsulated or bonded fibers are cooled.

In some embodiments, the bladder 10 having the one or more layers of precursor material 44 laid thereon is placed in an autoclave 48 as illustrated in FIG. 7. In alternate embodiments, the bladder 10 having the one or more layers of precursor material 44 laid thereon is placed in a curing press 50 as illustrated in FIG. 8. The autoclave 48 or the curing press 50 exert heat and pressure on the one or more layers of precursor material 44 to form the layered component 46.

Alternately, the one or more layers of precursor material 44 may be one or more layers of thermoplastic material, which include a glass transition temperature. The one or more layers of thermoplastic material are heated to a temperature above the glass transition temperature thereof. In this respect, the one or more layers of thermoplastic material are deformed into the thermoplastic component.

In (110), the working pressure in the chamber 22 of the bladder 10 is returned to the ambient pressure. In some embodiments, the Schrader valve or other valve opens to permit some of the fluid 24 to exit the chamber 22 if the working pressure therein is greater than the ambient pressure. In other embodiments, the Schrader valve or other valve opens to permit additional fluid 24 to enter the chamber 22 if the working pressure therein is less than the ambient pressure (i.e., a vacuum). (110) returns the bladder to the flaccid state, which permits shifting of the plurality of jamming media 26 within the chamber 22.

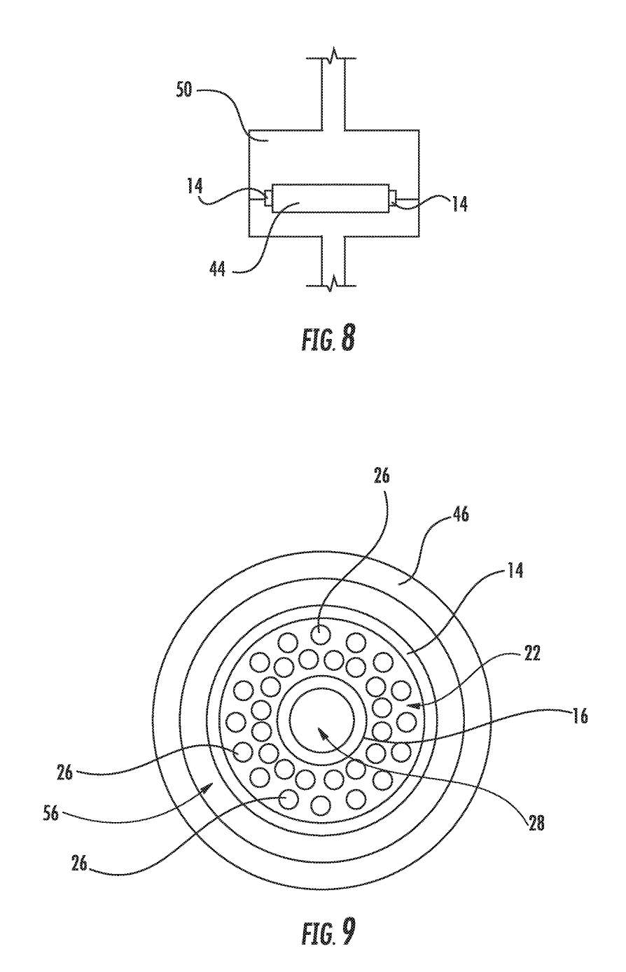

Referring to FIGS. 4 and 9, the bladder 10 is removed from the layered component 46 in (112). All of the plurality of jamming media 26 may remain in the chamber 22 of the bladder 10 during (112). In the embodiment illustrated in FIG. 9, the outer longitudinal wall 14 disengages the layered component 46 when the bladder 10 returns to the flaccid state, thereby creating a space 56 therebetween. The space 56 permits easy removal of the bladder 10 from the layered component 46. In other embodiments, however, the bladder 10 may still be in contact with the outer longitudinal wall 14 after (110). Nevertheless, the bladder 10 is malleable enough in the flaccid state to removal thereof from the layered component 46.

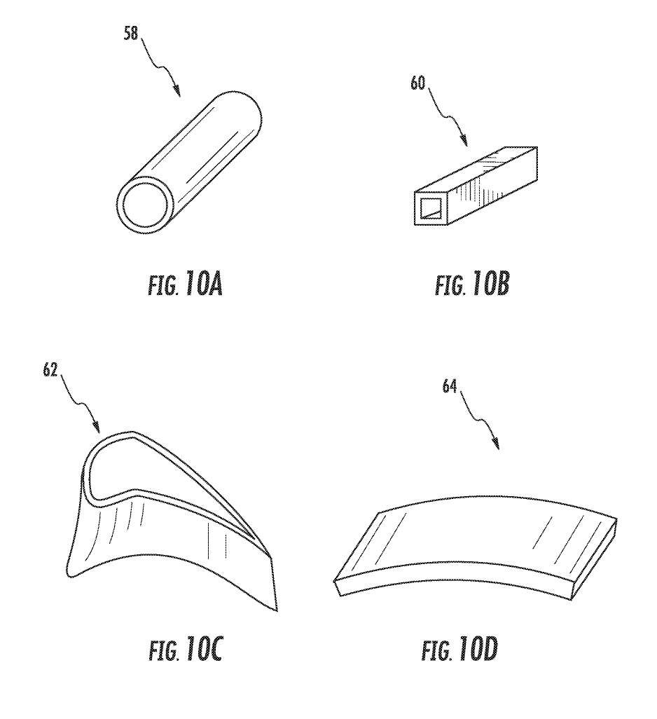

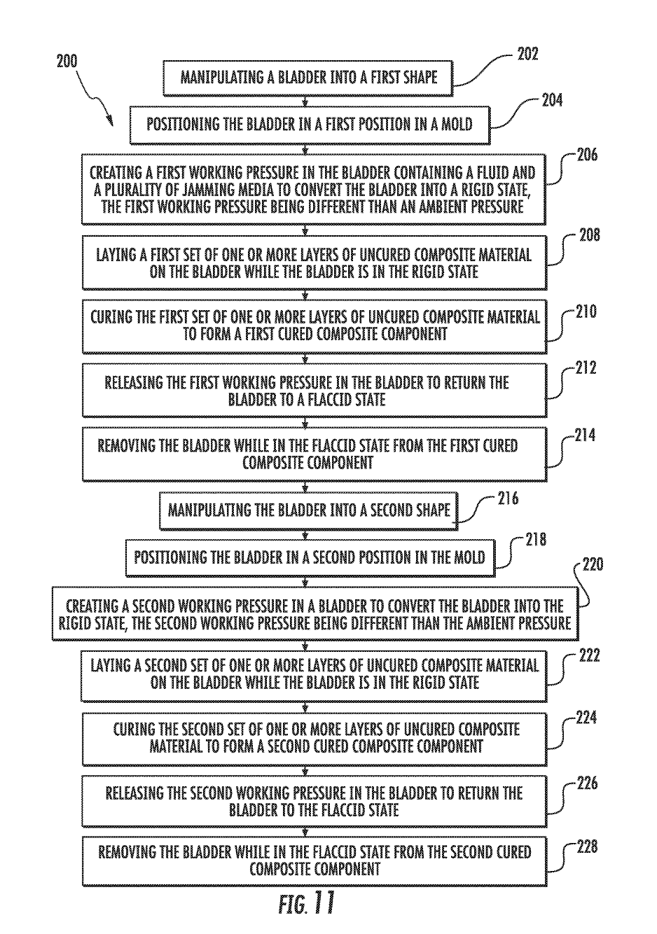

FIGS. 10A-10D illustrate various embodiments of the layered component 46 (e.g., the cured composite component or the thermoplastic component). Specifically, FIGS. 10A-10D respectively illustrate a tube 58, a duct 60 having a rectangular cross-section, an airfoil 62, and a curved panel 64. Nevertheless, the cured composite component 46 may have any suitable form or shape and may be any type of component. In one embodiment, the layered component 46 is an aircraft component (e.g., the airfoil 62). Although, the layered component 46 may be a component for use in any suitable application.

FIG. 11 is a flow chart illustrating an exemplary method (200) of manufacturing a composite component in accordance with the embodiments disclosed herein. In (202), the bladder 10 is manipulated into a first shape suitable for forming a first composite component. (202) is substantially similar to (102) of the method (100). In (204), the bladder 10, which has been manipulated into the first shape, is positioned in the mold cavity 42 of the mold 34 in a first position suitable for forming the first composite component. In (206), a first working pressure different than the ambient pressure is created in the chamber 22 of the bladder 10 to convert the bladder 10 to the rigid state. A first set of the one or more layers of uncured composite material is laid on the bladder 10 while the bladder 10 is in the rigid state in (208). The first set of the one or more layers of uncured composite material is cured to form a first cured composite component in (210). In (212), the first working pressure in the chamber 22 of the bladder 10 is returned to the ambient pressure to return the bladder 10 to the flaccid state. The bladder 10 is removed from the first cured composite component in (214). All of the plurality of jamming media 26 may remain in the chamber 22 of the bladder 10 during (214). (206)-(214) are respectively substantially similar to (104)-(112) of the method (100).

In (216), the bladder 10 is manipulated in a second shape suitable for forming a second composite component. In some embodiments, the second shape is different than the first shape. For example, the first shape may be an L-shape suitable for forming an L-shaped tube, while the second shape may an S-shape suitable for forming an S-shaped tube. Nevertheless, the first and the second shapes may be any suitable different shapes. In alternate embodiments, the first and the second shapes may be the same. The second composite component may be the same type of component as the first composite component (e.g., both are airfoils), but have different features (e.g., different passageways therein). Alternately, the first and the second components may be entirely different types of components.

The bladder 10 having been manipulated into the second shape is positioned in the mold cavity 42 of the mold 34 in a second position suitable for forming the second composite component in (218). The second position may be the same as the first position or different than the first position.

In (220), a second working pressure different than the ambient pressure is created in the chamber 22 of the bladder 10 to convert the bladder 10 to the rigid state. The second working pressure is preferably the same as the first working pressure, but may be different as well. A second set of the one or more layers of uncured composite material are laid on the bladder 10 while the bladder 10 is in the rigid state in (220). The second set of the one or more layers of uncured composite material is cured to form a second cured composite component in (224). In (226), the second working pressure in the chamber 22 of the bladder 10 is returned to the ambient pressure to return the bladder 10 to the flaccid state. The bladder 10 is removed from the cured composite component in (228). All of the plurality of jamming media 26 may remain in the chamber 22 of the bladder 10 during (228). (220)-(228) are respectively substantially similar to (104)-(112) of the method (100).

While method (200) was described above in the context of forming two different components, method (200) may be used to form different portions of the same component. For example, method (200) may be used to form a component that includes a first passage having a first shape and a second passage having a second shape. In this respect, (202)-(214) may form the first passage, and (214)-(228) may be used to form the second passage.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of manufacturing a layered component, comprising:
changing a working pressure in a bladder comprising a shape and containing a fluid and a plurality of jamming media to convert the bladder into a rigid state, the working pressure being different than an ambient pressure;
laying one or more layers of precursor material on the bladder while the bladder is in the rigid state;
processing the one or more layers of precursor material to form the layered component;
returning the working pressure in the bladder to the ambient pressure to return the bladder to a flaccid state; and
removing the bladder while in the flaccid state from the layered component.

2. The method of claim 1, wherein the layered component comprises a cured composite component, and wherein the precursor material comprises uncured composite material, and further wherein processing the one or more layers of precursor material comprises heating the uncured composite material to a temperature sufficient to cure the precursor material.

3. The method of claim 1, wherein the layered component comprises a thermoplastic component, and wherein the precursor material comprises the thermoplastic material having a glass transition temperature, and further wherein processing the one or more layers of precursor material comprises heating the thermoplastic material above the glass transition temperature.

4. The method of claim 3, further comprising:
deforming the one or more layers of thermoplastic material into the thermoplastic component.

5. The method of claim 1, wherein the plurality of jamming media remains contained within the bladder while removing the bladder while in the flaccid state from the layered component.

6. The method of claim 1, further comprising:
manipulating the bladder into the shape suitable for forming the layered component prior to creating the working pressure in the bladder.

7. The method of claim 1, wherein the working pressure is less than the ambient pressure.

8. The method of claim 1, wherein the working pressure is greater than the ambient pressure.

9. The method of claim 1, wherein processing the one or more layers of precursor material to form the layered component comprises heating the one or more layers of precursor material with an autoclave or a curing press, and wherein the cured composite component is a tube, a duct, an airfoil, or a curved panel.

10. The method of claim 1, wherein the plurality of jamming media comprises beads.

11. The method of claim 1, wherein the fluid comprises air or oil, and wherein the bladder is constructed from silicone.

12. A method of forming a cured composite component, comprising:
positioning a bladder in a first position in a mold;
applying a first working pressure in the bladder containing a fluid and a plurality of jamming media to convert the bladder into a rigid state, the first working pressure being different than an ambient pressure;
laying a first set of one or more layers of uncured composite material on the bladder while the bladder is in the rigid state;
curing the first set of one or more layers of uncured composite material to form a first cured composite component;
releasing the first working pressure in the bladder to return the bladder to a flaccid state;
removing the bladder while in the flaccid state from the first cured composite component
positioning the bladder in a second position in the mold;
applying a second working pressure in a bladder to convert the bladder into the rigid state, the second working pressure being different than the ambient pressure;
laying a second set of one or more layers of uncured composite material on the bladder while the bladder is in the rigid state;
curing the second set of one or more layers of uncured composite material to form a second cured composite component;
releasing the second working pressure in the bladder to return the bladder to the flaccid state; and
removing the bladder while in the flaccid state from the second cured composite component.

13. The method of claim 12, wherein the plurality of jamming media remains contained within the bladder while removing the bladder while in the flaccid state from the second cured composite component.

14. The method of claim 12, further comprising:
manipulating the bladder into a first shape before positioning a bladder in the first position.

15. The method of claim 14, further comprising:
manipulating the bladder into a second shape after releasing the first working pressure in the bladder.

16. The method of claim 15, wherein the first shape and the second shape are different.

17. The method of claim 15, wherein the first shape and the second shape are the same.

18. The method of claim 12, wherein the first working pressure and the second working pressure are the same.

19. The method of claim 12, wherein the composite component is a tube, a duct, an airfoil, or a curved panel.

20. A mold assembly for forming a composite component, comprising:
a permanently rigid mold;
a bladder comprising an internal chamber containing a fluid and a plurality of jamming media;
wherein the bladder is in a rigid state when a working pressure different than an ambient pressure is applied to the internal chamber and the bladder is in a flaccid state when the internal chamber is the same as the ambient pressure; and
wherein one or more layers of uncured composite material are laid on the permanently rigid mold and the bladder when in the rigid state form a composite component.
